(19) United States
(12) Patent Application Publication
(10) Pub. No.: US 2013/0230436 A1
(43) Pub. Date: Sep. 5, 2013

(54) HOLLOW FIBER MEMBRANE SEPARATOR WITH INTEGRAL OZONE CONVERTER

(71) Applicants: Bill Vestal, Milan, IL (US); Edward Tesch, Davenport, IA (US); Alan Yoder, Davenport, IA (US); Jeremy Schaeffer, Walcott, IA (US)

(72) Inventors: Bill Vestal, Milan, IL (US); Edward Tesch, Davenport, IA (US); Alan Yoder, Davenport, IA (US); Jeremy Schaeffer, Walcott, IA (US)

(21) Appl. No.: 13/780,599

(22) Filed: Feb. 28, 2013

Related U.S. Application Data
(60) Provisional application No. 61/605,513, filed on Mar. 1, 2012.

(51) Int. Cl. C01B 21/04

(52) U.S. Cl. CPC C01B 21/04
USPC 422/187

(57) ABSTRACT

A modular component is provided for use in a system for inerting void spaces in aircraft. The modular component is comprised of a hollow fiber membrane and tubesheet bundle, a low-temperature ozone converter, a hollow fiber membrane shell, and separator endcaps. The ozone converter can be any low-temperature converter with an ozone removal catalyst capable of high ozone removal efficiencies in the temperature range of 100 to 300° F. The modular component may further be used in a system comprising an additional low-temperature and high-temperature ozone converter upstream of the modular component.

### CROSS-REFERENCE TO RELATED APPLCIATION

This application claims the benefit of Provisional Application U.S. Ser. No. 61/605,513 filed on Mar. 1, 2012.

### BACKGROUND OF THE INVENTION

The present invention relates to air separation systems which function to separate nitrogen from a compressed air source, which may then be used to inert an open space such as a fuel tank or cargo hold of an airplane.

The method for air separation is accomplished with Hollow Fiber Membranes (HFM). The air separation systems take compressed air to generate nitrogen enriched air (NEA), with oxygen enriched air (OEA) being generated as the waste gas. The source of compressed air can be bleed air from the aircraft engine or auxiliary power unit (APU), or can be from ambient or aircraft cabin air that is pressurized with a feed air compressor. In all cases, the original source of air is from the ambient, which contains ozone. Since ozone exposure causes damage to the HFM polymers, an ozone catalytic converter is required upstream of the HFM to remove most of the ozone.

### SUMMARY OF THE INVENTION

The present invention addresses the above need by providing a modular design that contains both the hollow fiber membrane and the low-temperature ozone catalytic converter in one package. The modular component according to this invention comprises the following components packaged within a single housing:
a) the hollow fiber membrane and tubesheet bundle;
b) a low-temperature (<300° F.) ozone converter containing an ozone catalyst.

### BRIEF DESCRIPTION OF THE DRAWINGS

FIG. 1 is a 2-D drawing of the modular system according to this invention;

FIG. 2 is a schematic view of one embodiment of the invention;

FIG. 3 is a schematic view of an alternate embodiment of the invention;

FIG. 4 is a schematic view of a further alternate embodiment of the invention.

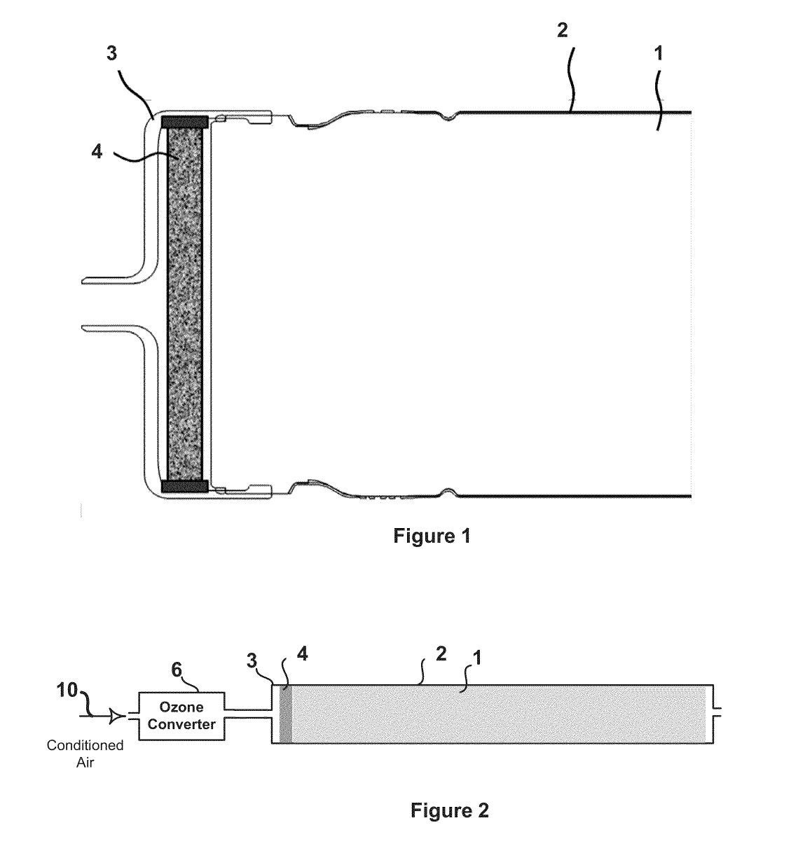

### DETAILED DESCRIPTION

The HFM separator is made up of the hollow fiber membrane itself with the epoxy tubesheet at both ends 1. The HFM and tubesheet is enclosed in an aluminum shell 2, and end caps 3 are connected to the shell by some method (bolts, welded, crimped) to complete the assembly. The invention pertains to modifying this current module by integrating the ozone converter 4 inside the housing of the separator. The ozone converter can be any low-temperature converter with an ozone removal catalyst capable of high ozone removal efficiencies in the temperature range of 100 to 300° F. The diameter of the converter 4 is the same as the diameter of the HFM and tubesheet. The length of the converter 4 is dependent of the ozone removal efficiency required.

There are several advantages of placing the low-temperature ozone converter inside the HFM separator. One advantage is better flow distribution across the face of the converter. In other applications where the converter is placed in a separate housing upstream of the Air Separation Module (ASM), there is not an excess of room to allow a large volume of converter, and it is difficult to provide adequate transition ducting to and from the converter. Without adequate transition ducting, the outer portions of the converter will be under-utilized, as a majority of the air will flow through the center of the converter, resulting in reduced ozone removal efficiency. In contrast, a large transition between the HFM end cap 3 and the tubesheet of the HFM is not required to ensure even air distribution across the face of the tubesheet. This is because the pressure drop across the HFM fiber is large compared to the pressure drop created by the gap between the end cap 3 and HFM tubesheet. Since the pressure drop across the ozone converter is also small in comparison to the HFM fiber, placing the ozone converter directly upstream of the HFM tubesheet will cause even distribution across the face of the converter without providing a large transition. Therefore this modular design (HFM separator with integral ozone converter) provides high ozone removal efficiency in a compact volume without the need of a second housing.

In many applications the ASM is made up of more than one HFM separator. When the low-temperature ozone converter is placed in a separate housing upstream of the ASM, that converter must be capable of handling the air flow of all the separators combined. Since the efficiency of the converter is a function of the residence time of the air inside the converter, a larger ozone converter is required for an ASM with more separators. This is disadvantageous for multiple reasons. For one, finding space for a separate large low-temperature ozone converter near the ASM may be difficult in an aircraft application. A second disadvantage is that there cannot be a common ozone converter component that can be used across multiple ASM products. An ASM that contains five HFM separators will required a larger ozone converter than an ASM that contains only two HFM separators. With the ozone converter integral to the HFM separator, the size of the converter does not have to change if the number of HFM separators used in the ASM increases or decreases. Also, since each HFM separator has the ozone converter integrated into the separator, the converter can be smaller in length since each converter will see less air flow (longer residence time) than if only one converter was used for the ASM.

Another advantage of the HFM separator with an integral ozone converter is a reduction in system components and also a reduction in components that must be replaced on aircraft. Since the ozone converter resides inside the HFM separator, it is located downstream of the ASM inlet filter. The ASM inlet filter removes liquid contaminants that can poison the ozone catalyst, allowing the ozone converter to remain on aircraft longer than if the converter was located separately upstream of the filter. By design, the ozone converters are replaced every time the HFM separator is replaced, instead of replacing the converters located in a separate package on aircraft.

In one embodiment of the invention, shown in FIG. 2, a low-temperature ozone converter 6 is located upstream of the ASM and receives thermally conditioned (low-temperature) compressed air 10. The first stage low-temperature ozone converter 6 removes a large amount of the ozone in the compressed air stream before the air enters the HFM, where the integral low-temperature ozone converter 4 removes more ozone from the air stream, providing the HFM polymer fibers with nearly ozone free air.

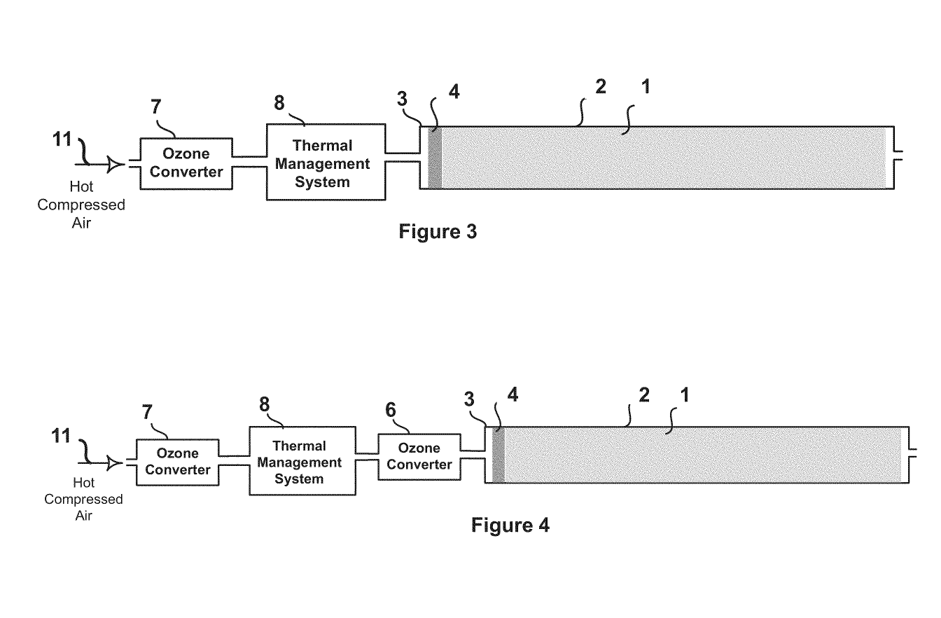

In another embodiment of the invention, shown in FIG. 3, a high-temperature ozone converter 7 is located upstream of the Air Separation Module (ASM) and the Thermal Management System 8 and receives hot compressed air 11. The high-temperature ozone converter 7 removes ozone more efficiently when provided air at high temperatures, so it is located upstream of the Thermal Management System 8. The ASM again receives thermally conditioned compressed air that has a large percent of the ambient ozone removed. The integral low-temperature ozone converter 4 removes more ozone from the air stream, providing the HFM polymer fibers with nearly ozone free air.

In a further additional embodiment of the invention, shown in FIG. 4, both a high-temperature ozone converter 7 and a low-temperature ozone converter 6 are used upstream of the ASM that contains an integral low-temperature ozone converter 4.

What is claimed is:

1. A modular component used in a system for inerting void spaces in aircraft, wherein modular component is comprised of a hollow fiber membrane and tubesheet bundle, a low-temperature ozone converter, a hollow fiber membrane shell, and separator endcaps.

2. The modular component of claim 1, wherein the ozone converter can be any low-temperature converter with an ozone removal catalyst capable of high ozone removal efficiencies in the temperature range of 100 to 300° F.

3. The modular component of claim 1, wherein it is used in a system comprising an additional low-temperature ozone converter upstream of the modular component.

4. The modular component of claim 1, wherein it is used in a system comprising an additional high-temperature ozone converter upstream of the modular component.

5. The modular component of claim 1, wherein it is used in a system comprising an additional low-temperature and high-temperature ozone converter upstream of the modular component.
